(19) United States
(12) Patent Application Publication
(10) Pub. No.: US 2011/0073978 A1
(43) Pub. Date: Mar. 31, 2011

(54) INFRARED IMAGING DEVICE AND METHOD FOR MANUFACTURING SAME

(75) Inventors: Ikuo FUJIWARA, Kanagawa-ken (JP); Hiroto Honda, Kanagawa-ken (JP); Keita Sasaki, Kanagawa-ken (JP)

(73) Assignee: Kabushiki Kaisha Toshiba, Tokyo (JP)

(21) Appl. No.: 12/888,465

(22) Filed: Sep. 23, 2010

Related U.S. Application Data
(63) Continuation of application No. PCT/JP2009/063890, filed on Aug. 5, 2009.

(30) Foreign Application Priority Data
Sep. 25, 2008 (JP) 2008-246850

(51) Int. Cl. H01L 31/102; H01L 31/18

(52) U.S. Cl. 257/440; 438/57; 257/E31.055

(57) ABSTRACT

According to one embodiment, an infrared imaging device includes a substrate, an infrared absorption unit, a thermoelectric conversion unit, a support body, and an interconnection. The infrared absorption unit is provided on the substrate and apart from the substrate to absorb an infrared ray. The thermoelectric conversion unit is provided apart from the substrate and in contact with the infrared absorption unit between the infrared absorption unit and the substrate. The thermoelectric conversion unit converts a temperature change due to the infrared ray absorbed by the infrared absorption unit into an electrical signal. The support body supports the thermoelectric conversion unit on the substrate and apart from the substrate and transmits the electrical signal. The interconnection transmits the electrical signal in reading the electrical signal. The infrared absorption unit includes a protrusion provided on a rim of the infrared absorption unit to protrude toward the substrate.

### CROSS-REFERENCE TO RELATED APPLICATIONS

This is a continuation application of International Application PCT/JP2009/063890, filed on Aug. 5, 2009. This application also claims priority to Japanese Application No. 2008-246850, filed on Sep. 25, 2008. The entire contents of each are incorporated herein by reference.

### FIELD

Embodiments described herein relate generally to an infrared imaging device and a method doe manufacturing the same.

### BACKGROUND

In recent years, the research and development of so-called MEMS (Micro Electro Mechanical Systems) including suspended structural bodies formed on semiconductor substrates have been performed actively.

Devices in which such MEMS are applied include infrared imaging devices. Of these, uncooled infrared imaging devices do not require a cooling mechanism, are capable of being downsized and provided on a chip, and have great promise for future development in applications in a wide range of fields.

Such an infrared imaging device includes an infrared detection unit that includes an infrared absorption unit for converting the incident infrared rays into heat and a thermoelectric conversion unit for converting the heat into an electrical signal. Thermally separating the infrared detection unit from its surroundings and increasing the thermoelectric conversion efficiency are important for increasing the detection sensitivity of infrared rays.

Therefore, methods are used to suppress the diffusion of heat to the surroundings by mounting the infrared imaging device in a vacuum package and removing the substrate and the element-separating oxide films around the infrared detection unit by etching and the like to make a cavity around the infrared detection unit.

Further, to increase the detection sensitivity, it is important to use a structure in which the surface area ratio of the infrared detection unit to the entirety is as high as possible to efficiently absorb the incident infrared rays.

As an infrared imaging device having such a structure, for example, a structure has been discussed in which a temperature sensor, a thermally insulating support leg supporting the temperature sensor, and an infrared absorption layer formed to thermally contact the temperature sensor are provided; and the temperature sensor, the thermally insulating support leg, and the infrared absorption layer are formed in different planes spatially separated from each other (for example, refer to JP-A 2004-317152 (Kokai)).

On the other hand, technology also has been proposed to provide an eave-like portion in an infrared light receiving unit to increase the detection sensitivity (for example, refer to JP-A 2005-43381 (Kokai)).

In suspended structural bodies of such infrared absorption layers, eave-like portions, and the like, it is desirable to increase the surface area as much as possible to increase the sensitivity, while it is desirable to reduce the volume as much as possible to increase the response rate. Therefore, as a result, the thicknesses are designed to be thin. Therefore, the mechanical strength of the infrared absorption layer and the eave-like portion decrease; and the configurations easily deform. Accordingly, for example, the suspended structural body deforms due to internal stress during the formation of the suspended structural body and fluctuation of the process conditions; a phenomenon called sticking occurs in which the suspended structural body sticks to the substrate and interconnections disposed therearound; and as a result, the detection sensitivity of the infrared imaging device decreases.

### BRIEF DESCRIPTION OF THE DRAWINGS

FIGS. 1A to 1C are schematic views illustrating an infrared imaging device according to a first embodiment;

FIGS. 2A and 2B are schematic cross-sectional views illustrating infrared imaging devices of comparative examples;

FIGS. 3A to 3C are schematic views illustrating infrared imaging devices of variation examples according to the first embodiment;

FIG. 4 is a schematic cross-sectional view illustrating an infrared imaging device according to a first example;

FIGS. 5A to 5C are schematic cross-sectional views in order of the processes, illustrating a method for manufacturing the infrared imaging device according to the first example;

FIGS. 6A to 6C are schematic cross-sectional views in order of the processes, continuing from FIG. 5C;

FIGS. 7A to 7C are schematic cross-sectional views in order of the processes, continuing from FIG. 6C;

FIGS. 8A to 8C are schematic cross-sectional views in order of the processes, continuing from FIG. 7C;

FIGS. 9A and 9B are schematic views illustrating an infrared imaging device according to a second example;

FIG. 10 is a graph illustrating a characteristic of the infrared imaging device according to the first embodiment; and

FIG. 11 is a flowchart illustrating a method for manufacturing an infrared imaging device according to a second embodiment.

### DETAILED DESCRIPTION

In general, according to one embodiment, an infrared imaging device includes a substrate, an infrared absorption unit, a thermoelectric conversion unit, a support body, and an interconnection. The infrared absorption unit is provided on the substrate and apart from the substrate to absorb an infrared ray. The thermoelectric conversion unit is provided apart from the substrate and in contact with the infrared absorption unit between the infrared absorption unit and the substrate. The thermoelectric conversion unit is configured to convert a temperature change due to the infrared ray absorbed by the infrared absorption unit into an electrical signal and to output the electrical signal. The support body supports the thermoelectric conversion unit on the substrate and apart from the substrate and is configured to transmit the electrical signal. The interconnection is connected with the support body and configured to transmit the electrical signal in reading the electrical. The infrared absorption unit includes a protrusion provided on a rim of the infrared absorption unit to protrude toward the substrate.

According to another embodiment, an infrared imaging device includes a substrate, an infrared absorption unit, a thermoelectric conversion unit, a support body, and an interconnection. The infrared absorption unit is provided on the substrate and apart from the substrate to absorb an infrared ray. The thermoelectric conversion unit is provided apart from the substrate and in contact with the infrared absorption unit between the infrared absorption unit and the substrate. The thermoelectric conversion unit is configured to convert a temperature change due to the infrared ray absorbed by the infrared absorption unit into an electrical signal and to output the electrical signal. The support body supports the thermoelectric conversion unit on the substrate and apart from the substrate and is configured to transmit the electrical signal. The interconnection is connected with the support body and configured to transmit the electrical signal in reading the electrical signal. The infrared absorption unit includes a thick portion on a rim of the infrared absorption unit. A thickness of the thick portion is thicker than a thickness of a central portion of the infrared absorption unit.

According to yet another embodiment, a method is disclosed for manufacturing an infrared imaging device. The device includes a substrate, an infrared absorption unit, a thermoelectric conversion unit, a support body, and an interconnection. The infrared absorption unit is provided on the substrate and apart from the substrate to absorb an infrared ray. The thermoelectric conversion unit is provided apart from the substrate and in contact with the infrared absorption unit between the infrared absorption unit and the substrate to convert a temperature change due to the infrared ray absorbed by the infrared absorption unit into an electrical signal and to output the electrical signal. The support body supports the thermoelectric conversion unit on the substrate and apart from the substrate and is configured to transmit the electrical signal. The interconnection is connected with the support body and configured to transmit the electrical signal in reading the electrical signal. The method can form the thermoelectric conversion unit and the support body on the substrate. The method can deposit a sacrificial layer by chemical vapor deposition to cover the thermoelectric conversion unit and the support body. The method can form an infrared absorption film served as the infrared absorption unit on the sacrificial layer and patterning a configuration of the infrared absorption film. In addition, the method can remove the sacrificial layer.

Embodiments will now be described in detail with reference to the drawings.

The drawings are schematic or conceptual; and the relationships between the thickness and width of portions, the proportions of sizes among portions, etc., are not necessarily the same as the actual values thereof. Further, the dimensions and the proportions may be illustrated differently among the drawings, even for identical portions.

In the specification and the drawings of the application, components similar to those described in regard to a drawing thereinabove are marked with like reference numerals, and a detailed description is omitted as appropriate.

### First Embodiment

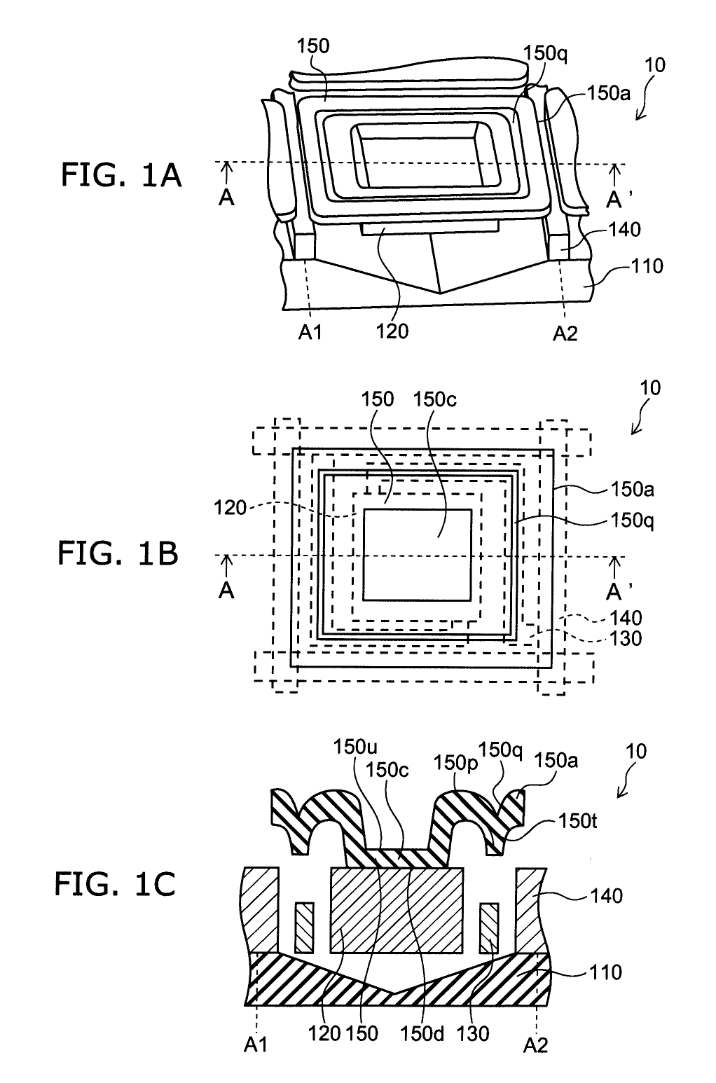

FIGS. 1A to 1C are schematic views illustrating the configuration of an infrared imaging device according to a first embodiment.

Namely, FIG. 1A is a schematic perspective view; FIG. 1B is a plan view; and FIG. 1C is a cross-sectional view along line A-A′ of FIGS. 1A and 1B.

As illustrated in FIGS. 1A to 1C, the infrared imaging device 10 according to the first embodiment includes a substrate 110, an infrared absorption unit 150, a thermoelectric conversion unit 120, a support body 130, and an interconnection 140.

The infrared absorption unit 150 is provided on the substrate 110 and apart from the substrate 110 and absorbs infrared rays.

The thermoelectric conversion unit 120 is provided apart from the substrate 110 between the infrared absorption unit 150 and the substrate 110 and converts a temperature change due to infrared rays absorbed by the infrared absorption unit 150 into an electrical signal. For better heat conduction from the infrared absorption unit 150 to the thermoelectric conversion unit 120, the infrared absorption unit 150 and the thermoelectric conversion unit 120 may be provided, for example, in contact with each other.

The thermoelectric conversion unit 120 may include a silicon pn junction diode. Thereby, the change of the heat can be converted into an electrical signal with low noise and high sensitivity. The thermoelectric conversion unit 120 also may include resistance elements, transistors, etc.

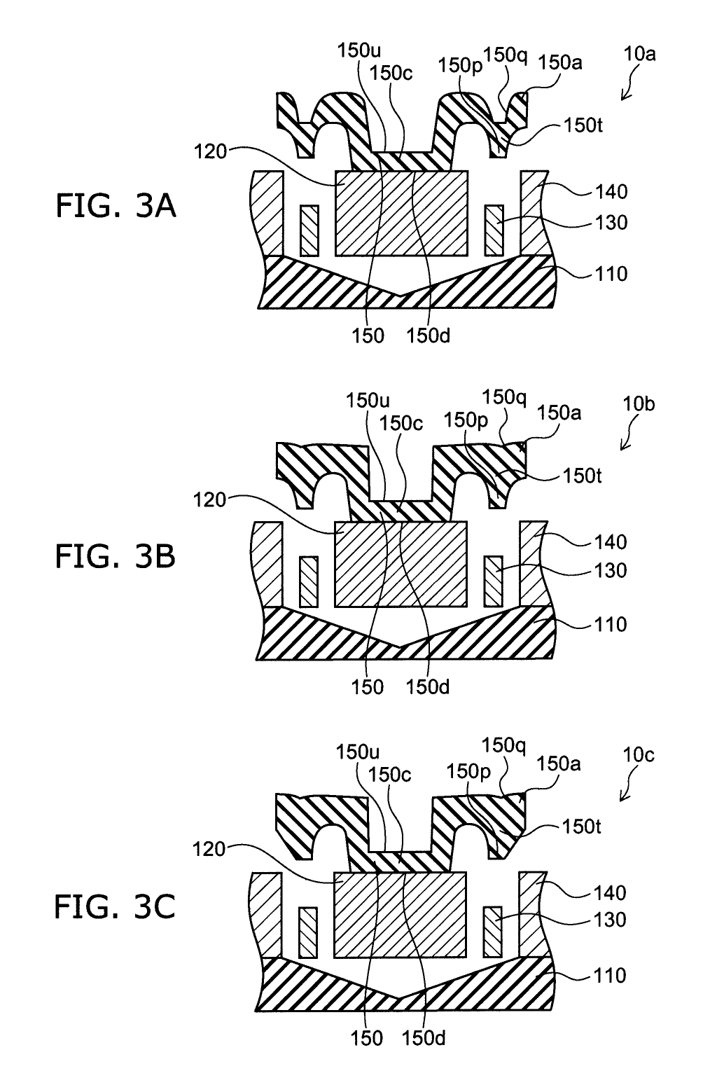

The support body 130 transmits the electrical signal from the thermoelectric conversion unit 120 while supporting the thermoelectric conversion unit 120 on the substrate 110 and apart from the substrate 110. To reduce the heat conduction as much as possible, it is desirable for the support body 130 to include a material having a low thermal conductivity and for the support body 130 to be as thin and long as possible within the extent of design feasibility. For example, in this specific example as illustrated in FIG. 3B, the support body 130 is disposed with a thinner and longer configuration by having a spiral configuration.

The infrared absorption unit 150, the thermoelectric conversion unit 120, and the support body 130 are provided apart from the substrate 110 to reduce the heat conduction to the substrate 110. The infrared absorption unit 150, the thermoelectric conversion unit 120, and the support body 130 are maintained in a cavity. Hereinbelow, the infrared absorption unit 150 in particular is referred to as a suspended structural body.

One end of the support body 130 is connected to the thermoelectric conversion unit 120; and the other end is connected to the interconnection 140 provided at the periphery of the thermoelectric conversion unit 120.

The interconnection 140 reads the electrical signal from the support body 130.

The infrared absorption unit 150, the thermoelectric conversion unit 120, and the support body 130 form one infrared detection element, i.e., a pixel.

The pixel is multiply provided, for example, in a matrix configuration to form an infrared imaging region. The interconnection 140 is provided in a lattice configuration between each of the pixels; the output of the thermoelectric conversion unit 120 of each of the pixels is drawn out of the infrared imaging region via the support body 130 and the interconnection 140; and the intensity of the infrared rays detected by each of the pixels is output.

The region between line A1 and line A2 of FIGS. 1A to 1C is one pixel region.

The infrared absorption unit 150 is provided, for example, to cover the thermoelectric conversion unit 120, the support body 130, and a portion of the interconnection 140 and is designed to reduce the insensitive region as much as possible.

The structural body illustrated in FIGS. 1A to 1C is vacuum-sealed in a not-illustrated package.

Herein, the face of the infrared absorption unit 150 opposing the substrate is referred to as a lower face 150d; and the face of the infrared absorption unit 150 opposite to the lower face 150d is referred to as an upper face 150u.

In the infrared imaging device 10 according to this embodiment, the infrared absorption unit 150 includes a protrusion 150p provided on a rim 150a of the infrared absorption unit 150 to protrude toward the substrate 110. The protrusion 150p is provided, for example, along the rim 150a of the infrared absorption unit 150.

In other words, the lower face 150d at the protrusion 150p protrudes further toward the substrate 110 side than does the lower face 150d around the protrusion 150p.

In this specific example, the lower face 150d at the protrusion 150p is disposed higher than the lower face 150d at the portion of the infrared absorption unit 150 contacting the thermoelectric conversion unit 120 as viewed from the substrate 110 (in the direction away from the substrate as viewed from the substrate).

The face of the thermoelectric conversion unit 120 on the side opposite to the substrate 110 is higher than the face of the support body 130 on the side opposite to the substrate 110.

In this specific example, the upper face 150u of the portion corresponding to the protrusion 150p has a configuration substantially conforming to the lower face 150d of the protrusion 150p. In other words, the infrared absorption unit 150 further has a trench 150q provided on the face (the upper face 150u) of the infrared absorption unit 150 on the side opposite to the substrate 110 on the backside of the protrusion 150p, where the trench 150q is recessed toward the substrate 110 side. In other words, the cross-sectional configuration of the infrared absorption unit 150 at the protrusion 150p is a Y-shaped configuration. In the case where the protrusion 150p is provided, for example, along the rim 150a, the trench 150q is provided along the protrusion 150p. In other words, the trench 150q is provided along the rim 150a.

The mechanical strength of the infrared absorption unit 150 is increased by providing the protrusion 150p and the trench 150q along the rim 150a of the infrared absorption unit 150.

Thus, by the infrared imaging device 10 according to this embodiment, sticking can be suppressed by increasing the mechanical strength of the suspended structural body; and a highly sensitive infrared imaging device can be provided.

As illustrated in FIGS. 1A to 1C, the film thickness of the infrared absorption unit 150 at the portion of the protrusion 150p and the trench 150q is thicker than the film thickness of the infrared absorption unit 150 at a central portion 150c of the infrared absorption unit 150. In other words, the infrared absorption unit 150 includes a thick portion 150t provided at the rim 150a of the infrared absorption unit 150 and having a thickness thicker than that of the central portion 150c of the infrared absorption unit 150. The thick portion 150t is provided, for example, along the rim 150a of the infrared absorption unit 150. Thereby, sticking can be suppressed and a highly sensitive infrared imaging device can be provided by increasing the mechanical strength of the suspended structural body and increasing the infrared absorption efficiency.

### COMPARATIVE EXAMPLES

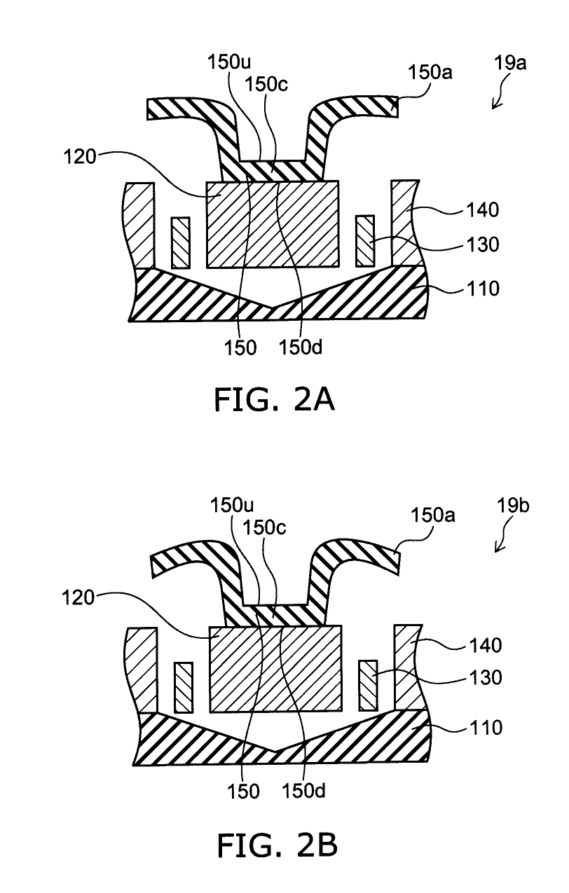

FIGS. 2A and 2B are schematic cross-sectional views illustrating the configurations of infrared imaging devices of comparative examples.

Namely, FIG. 2A illustrates the structure of an infrared imaging device 19a of a first comparative example; and FIG. 2B illustrates the structure of an infrared imaging device 19b of a second comparative example.

In the infrared imaging device 19a of the first comparative example as illustrated in FIG. 2A, the configuration of the infrared absorption unit 150 is different from that of the infrared imaging device 10 according to this embodiment. In other words, the infrared absorption unit 150 of the infrared imaging device 19a has, for example, the eave-like configuration discussed in JP-A 2005-43381 (Kokai).

In other words, although the peripheral region of the infrared absorption unit 150 has an eave-like portion apart from the substrate 110, the peripheral region has a flat cross-sectional structure; and the protrusion 150p and the trench 150q are not provided toward the substrate 110. The film thickness of the infrared absorption unit 150 is substantially uniform from the central portion 150c to the rim 150a; and the thick portion 150t is not provided. Therefore, the mechanical strength of the infrared absorption unit 150 is low; a sticking phenomenon occurs in which, for example, the suspended structural body deforms due to internal stress and fluctuation of the process conditions and the suspended structural body sticks to the substrate and the interconnections disposed therearound; and the sensitivity decreases.

In the infrared imaging device 19b of the second comparative example as illustrated in FIG. 2B as well, the configuration of the infrared absorption unit 150 is different from that of the infrared imaging device 10 according to this embodiment. In other words, the infrared absorption unit 150 of the infrared imaging device 19a has a configuration in which the eave-like configuration of the infrared imaging device 19a is bent in the substrate 110 direction at the rim 150a.

In other words, in such a case as well, the protrusion 150p and the trench 150q are not provided toward the substrate 110. Also, the film thickness of the infrared absorption unit 150 is substantially uniform from the central portion 150c to the rim 150a; and the thick portion 150t is not provided. To this end, in such a case as well, the mechanical strength of the infrared absorption unit 150 is low; the sticking phenomenon occurs in which, for example, the suspended structural body deforms due to internal stress and fluctuation of the process conditions and the suspended structural body sticks to the substrate and the interconnections disposed therearound; and the sensitivity decreases.

Conversely, the protrusion 150p is provided along the rim 150a in the infrared imaging device 10 according to this embodiment. Therefore, the low mechanical strength of the rim 150a is increased. Further, the mechanical strength is increased because the film thickness of the infrared absorption unit 150 is thicker and the thick portion 150t is provided at the portion of the protrusion 150p. In such a case, by providing the trench 150q in a position corresponding to the protrusion 150p, an increase of the volume of the infrared absorption unit 150 due to the protrusion 150p being provided can be suppressed; and the thermal capacity of the entirety can be maintained in a low state as much as possible.

FIGS. 3A to 3C are schematic views illustrating the configurations of infrared imaging devices of variation examples according to the first embodiment.

In an infrared imaging device 10a of a variation example according to this embodiment as illustrated in FIG. 3A, although the protrusion 150p and the trench 150q are provided in the infrared absorption unit 150, the configuration of the trench 150q is different from that of the infrared imaging device 10. In other words, the infrared imaging device 10 illustrated in FIGS. 1A to 1C is an example in which the trench 150q of the infrared absorption unit 150 has a V-shaped configuration and a face substantially parallel to the major surface of the substrate 110 is not provided in the trench 150q.

On the other hand, in the infrared imaging device 10a as illustrated in FIG. 3A, a bottom face substantially parallel to a major surface of the substrate 110 is provided in the trench 150q of the infrared absorption unit 150.

The cross-sectional configurations of the trench 150q and the protrusion 150p change due to the distance between the thermoelectric conversion unit 120 and the interconnection 140 and the structure of the support body 130 provided therebetween. Thus, the cross-sectional configuration of the trench 150q (and the protrusion 150p) is arbitrary.

In the case of the infrared imaging device 10a as well, the film thickness of the infrared absorption unit 150 is thick at the portion of the protrusion 150p and the trench 150q. In other words, although there is little difference between the film thicknesses of the central portion 150c and the portion at the bottom face of the trench 150q, the film thickness at the portion of the wall face of the trench 150q is thick. In other words, in this specific example, the thick portion 150t is the portion of the wall face of the trench 150q.

Thus, in the case where the trench 150q has a bottom face parallel to the major surface of the substrate 110, the protrusion 150p and the trench 150q are provided along the rim 150a where the mechanical strength is low. Therefore, the mechanical strength can be increased; the sticking can be suppressed; and a highly sensitive infrared imaging device can be provided.

In an infrared imaging device 10b of a variation example according to this embodiment as illustrated in FIG. 3B, although the protrusion 150p is provided in the infrared absorption unit 150, the depth of the trench 150q is shallower than that of the infrared imaging device 10. In such a case as well, the thick portion 150t is provided. In such a case as well, the mechanical strength can be increased; the sticking can be suppressed; and a highly sensitive infrared imaging device can be provided.

The depth of the trench 150q may be reduced further and the trench 150q may be substantially not provided. In such a case as well, the mechanical strength can be increased. However, as described above, in the case where the protrusion 150p is provided and the depth of the trench 150q is reduced radically or the trench 150q is not provided, the volume of the infrared absorption unit 150 increases and the thermal capacity increases. Therefore, it is desirable to provide the trench 150q with an appropriate depth. However, according to the relationship between the protrusion amount and width of the protrusion 150p and the film thickness and total surface area of the infrared absorption unit 150, it is not always necessary to provide the trench 150q, and only the protrusion 150p may be provided.

In an infrared imaging device 10c of a variation example according to this embodiment as illustrated in FIG. 3C, although the protrusion 150p is provided in the infrared absorption unit 150, the protrusion 150p is provided linked to the rim 150a. In other words, in the infrared imaging devices 10, 10a, and 10b recited above, the protruding portion 150p is provided proximally to the rim 150a along the rim 150a; and the lower face 150d at the portion of the protrusion 150p opposing the substrate 110 is positioned further toward the substrate 110 side than is the lower face 150d at the rim 150a. Conversely, in the infrared imaging device 10c, the position (the height) with respect to the substrate 110 of the lower face 150d at the portion of the protrusion 150p opposing the substrate 110 is substantially the same as the position (the height) of the lower face 150d at the rim 150a.

Thus, in the case where the protrusion 150p is provided linked to the rim 150a as well, the rim 150a where the mechanical strength of the infrared absorption unit 150 is low can be reinforced by the protrusion 150p; the mechanical strength of the infrared absorption unit 150 can be increased; the sticking can be suppressed; and a highly sensitive infrared imaging device can be provided.

Although the trench 150q may not be provided in such a case as well, as recited above, it is desirable for the trench 150q to be provided. In the case of the infrared imaging device 10c, the thick portion 150t corresponds to the portion where the protrusion 150p is provided.

In the infrared imaging devices 10, 10a, 10b, and 10c according to this embodiment, it is desirable for the protrusion 150p and the trench 150q to be provided along the rim 150a of the infrared absorption unit 150. Further, it is desirable for the protrusion 150p and the trench 150q to be provided continuously to enclose the central portion 150c of the infrared absorption unit 150 on the inner side of the rim 150a. Thereby, the strength of the rim 150a of the infrared absorption unit 150 can be increased further.

Because the mechanical strength of the rim 150a is low, it is desirable for the protrusion 150p and the trench 150q to be provided in portions as proximal as possible to the rim 150a to reinforce the mechanical strength.

Similarly, it is desirable to provide the thick portion 150t along the rim 150a of the infrared absorption unit 150 in the infrared imaging devices 10, 10a, 10b, and 10c according to this embodiment. Further, it is desirable for the thick portion 150t to be provided continuously to enclose the central portion 150c of the infrared absorption unit 150. Thereby, the strength of the rim 150a of the infrared absorption unit 150 increases further.

However, the embodiments are not limited thereto. It is sufficient for the protrusion 150p, the trench 150q, and the thick portion 150t to be provided along the rim 150a of the infrared absorption unit 150; and these may be provided, for example, intermittently in a portion of the sides or a portion of the corners of the rim 150a of the infrared absorption unit 150.

### First example

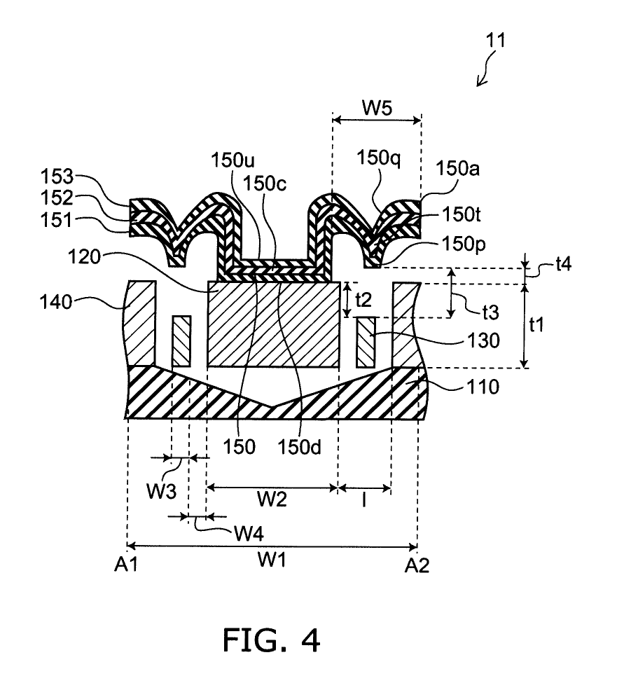

FIG. 4 is a schematic cross-sectional view illustrating the structure of an infrared imaging device according to a first example.

The infrared imaging device 11 according to the first example of this embodiment as illustrated in FIG. 4 has the structure of the infrared imaging device 10 illustrated in FIGS. 1A to 1C.

The pitch of the pixel in the infrared imaging device 11, i.e., a width W1 from line A1 to line A2, is 30 μm. A width W2 of the thermoelectric conversion unit 120 is 20 μm; a width W3 of the support body 130 is 1.0 μm; and a width (a distance) W4 between the support body 130 and the thermoelectric conversion unit 120 is 0.5 μm. The distance between the support body 130 and the interconnection 140 also is 0.5 μm.

A height t1 of the interconnection 140 (the height from the substrate 110) is 4.3 μm. A distance t2 between the face of the thermoelectric conversion unit 120 on the side opposite to the substrate 110 and the face of the support body 130 on the side opposite to the substrate 110 is 2.0 μm. A distance t3 between the support body 130 and the lower face 150d at the protrusion 150p of the infrared absorption unit 150 is 3.0 μm.

As recited above, the face of the support body 130 on the side opposite to the substrate 110 is more proximal to the substrate 110 side than is the face of the thermoelectric conversion unit 120 on the side opposite to the substrate 110; and a difference in levels exists. In other words, the face of the thermoelectric conversion unit 120 on the side opposite to the substrate 110 is higher than the face of the support body 130 on the side opposite to the substrate 110. Thereby, as described below, in the case where a sacrificial layer is provided on the thermoelectric conversion unit 120 and the support body 130 to cover the thermoelectric conversion unit 120 and the support body 130, the height of the sacrificial layer changes due to the difference in levels. As a result, the protrusion 150p and the trench 150q can be provided in the infrared absorption unit 150 formed on the sacrificial layer.

In this specific example, the infrared absorption unit 150 has a stacked structure of, for example, a lower absorption layer 151 (a first infrared absorption layer) made of a silicon oxide film, an upper absorption layer 153 (a second infrared absorption layer) made of a silicon oxide film provided to oppose the lower absorption layer 151, and an intermediate absorption layer 152 (a third infrared absorption layer) made of a Si₃N₄ film provided between the lower absorption layer 151 and the upper absorption layer 153. The silicon oxide film has an absorption peak in a wavelength region of about 9 μm. On the other hand, the Si₃N₄ film has an absorption peak in a wavelength region of about 13 μm. In other words, the light absorption wavelength regions of the two are different. Thereby, by providing the infrared absorption unit 150 with a stacked structure of different materials as in this specific example, the infrared absorption unit 150 can have good absorption characteristics with respect to a wide wavelength range; and the sensitivity to infrared rays increases.

In the case where different materials are stacked, it is desirable to employ a structure using the same material as the lower absorption layer 151 and the upper absorption layer 153 and a material different therefrom as the intermediate absorption layer 152 because the internal stress occurring between the different materials can be cancelled. The combination of the material used as the lower absorption layer 151 and the upper absorption layer 153 and the material used as the intermediate absorption layer 152 may be set appropriately based on the absorption characteristics of infrared rays, the mechanical strength, the suitability of the manufacturing processes, etc.

Also in the infrared imaging device 11 having such a structure, the low mechanical strength of the rim 150a is reinforced by the protrusion 150p and the thick portion 150t; the increase of the volume of the infrared absorption unit 150 is suppressed by the trench 150q; the mechanical strength of the infrared absorption unit 150 can be increased; the sticking can be suppressed; and a highly sensitive infrared imaging device can be provided.

A method for manufacturing the infrared imaging device 11 of this example will now be described.

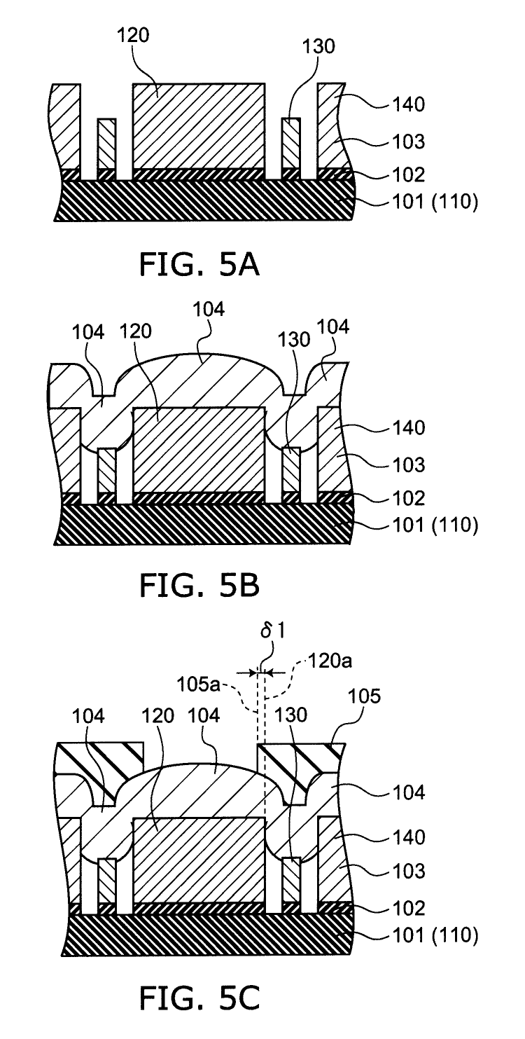

FIGS. 5A to 5C are schematic cross-sectional views in order of the processes, illustrating the method for manufacturing the infrared imaging device according to the first example. The structures inside the interconnection 140, the support body 130, and the pn junction diode, i.e., the thermoelectric conversion unit 120, are not illustrated.

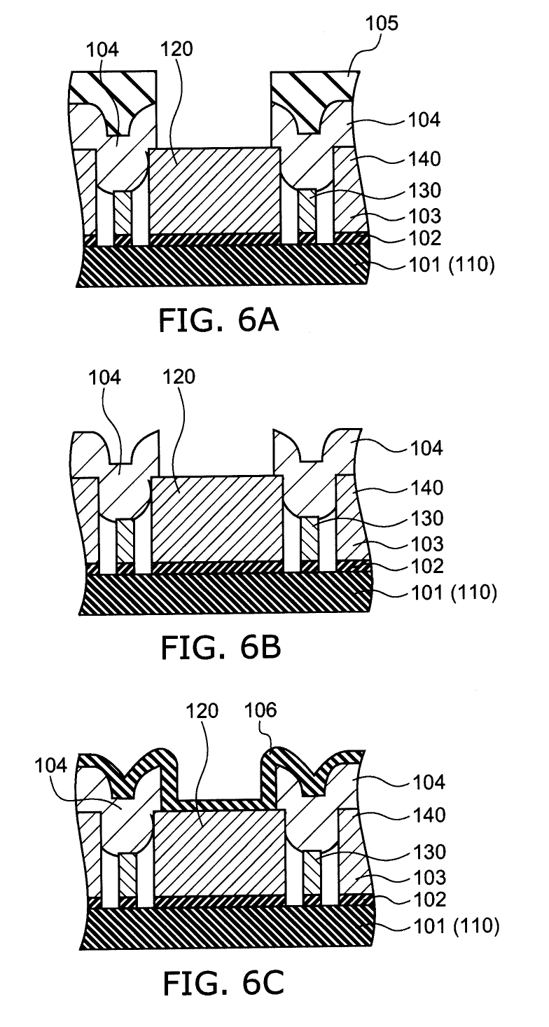

FIGS. 6A to 6C are schematic cross-sectional views in order of the processes, continuing from FIG. 5C.

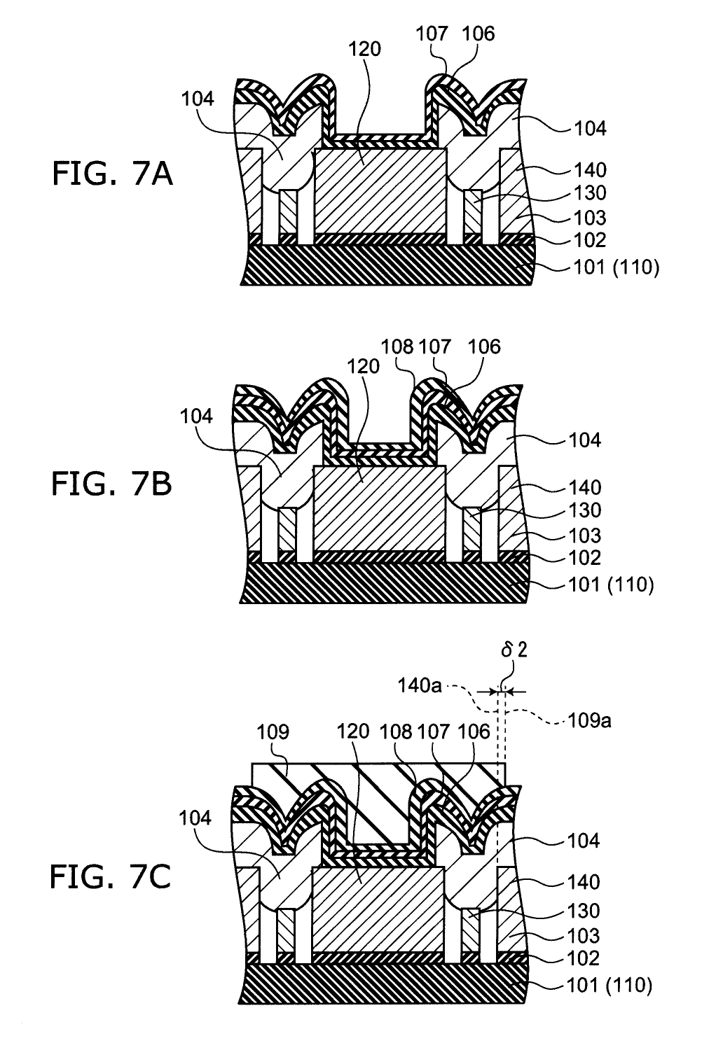

FIGS. 7A to 7C are schematic cross-sectional views in order of the processes, continuing from FIG. 6C.

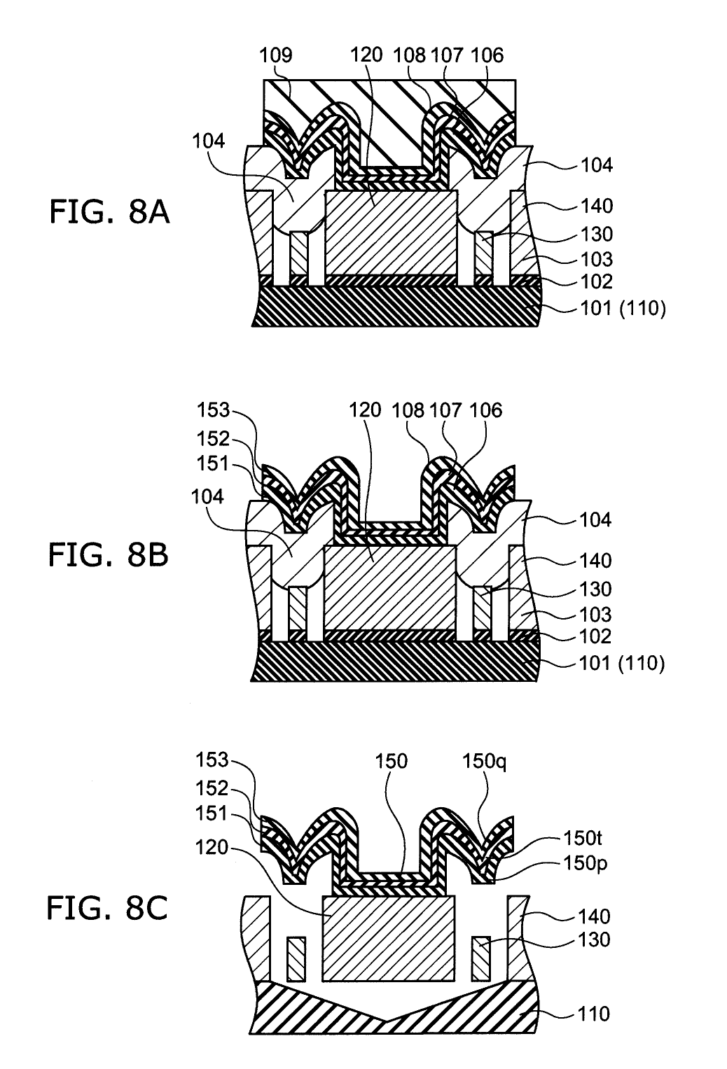

FIGS. 8A to 8C are schematic cross-sectional views in order of the processes, continuing from FIG. 7C.

As illustrated in FIG. 5A, first, a buried silicon oxide film layer 102 and a monocrystalline silicon layer 103 are stacked sequentially on a monocrystalline silicon support substrate 101. In other words, an SOI substrate is formed. The monocrystalline silicon support substrate 101 corresponds to the substrate 110.

Then, element separation is performed by STI (Shallow Trench Isolation). In other words, an element separation region is specified using photolithography; the monocrystalline silicon layer 103 of the element separation region is removed by etching using RIE (Reactive Ion Etching); subsequently, an element-separating silicon oxide film (not illustrated) is filled using CVD (Chemical Vapor Deposition); and planarizing is performed using CMP (Chemical Mechanical Polishing). At this time, the region which is the support structure also is defined as the element separation region and the element-separating silicon oxide film is filled.

Continuing, the pn junction diode served as the thermoelectric conversion unit 120 is formed. At this time, for example, an n⁺ electrode region is specified using photolithography; an n⁺ diffusion layer region is formed in a region of the monocrystalline silicon layer 103 proximal to the surface using ion implantation; then, a p⁺ electrode region is formed in a deep region of the monocrystalline silicon layer 103; and a diffusion layer interconnection region is formed to link the p⁺ electrode region to the contact diffusion layer region existing in the surface of the monocrystalline silicon layer 103.

Then, a polysilicon layer is formed; and the support body 130 is formed using photolithography and RIE. During this process, the gate electrodes of the MOS transistors used in the peripheral circuit, etc., may be formed simultaneously.

Continuing, a first inter-layer insulating film is formed using CVD. Subsequently, RIE and the like are used to make contact holes on the n⁺/p⁺ layer regions of the pn junction diode and in contact portions between the Al interconnection and the polysilicon forming the electrode support structure; and subsequently, plugs are filled by sputtering and CMP. Subsequently, aluminum alloy is deposited by sputtering and patterned to form the first metal interconnection. Subsequently, as described below, a silicon oxide film and a silicon nitride film are formed by stacking as layers served as the infrared absorption unit 150 and passivation of the MOS transistors and the like.

Then, as illustrated in FIG. 5B, etch-back is performed on the thermoelectric conversion unit 120, the support body 130, the interconnection 140, and the buried silicon oxide film layer 102 using a dry process. Subsequently, an amorphous silicon film is deposited with a thickness of 3 μm using CVD (Chemical Vapor Deposition) at 350° C. as a sacrificial layer 104.

Continuing, as illustrated in FIG. 5C, a resist 105 is formed on the sacrificial layer 104 and patterned into a prescribed configuration using photolithography. At this time, the distance from an end portion 105a of the resist 105 to an end portion 120a of the thermoelectric conversion unit 120, i.e., an overlap δ1 between the resist 105 and the thermoelectric conversion unit 120, is set to be greater than 0 μm and less than 1 μm.

Then, as illustrated in FIG. 6A, the amorphous silicon film of the sacrificial layer 104 on the upper face of the thermoelectric conversion unit 120 is removed using RIE.

Continuing, as illustrated in FIG. 6B, the resist 105 is peeled.

Then, as illustrated in FIG. 6C, a Si₃N₄ film 106 served as the lower absorption layer 151 of the infrared absorption unit 150 is formed using CVD.

Continuing as illustrated in FIG. 7A, a SiO₂ film 107 served as the intermediate absorption layer 152 of the infrared absorption unit 150 is formed on the Si₃N₄ film 106 recited above using CVD.

Then, as illustrated in FIG. 7B, a Si₃N₄ film 108 served as the upper absorption layer 153 of the infrared absorption unit 150 is formed using CVD.

Continuing as illustrated in FIG. 7C, a resist 109 is formed, and the resist 109 is patterned into a prescribed configuration using photolithography. At this time, to reduce the region insensitive to the infrared rays, it is desirable for the distance from an end portion 109a of the resist 109 to an end portion 140a of the interconnection 140, that is, an overlap δ2 between the resist 109 and the interconnection 140, to be set to be greater than 0 μm and less than half the width of the interconnection 140.

Then, as illustrated in FIG. 8A, the Si₃N₄ film 108, the SiO₂ film 107, and the Si₃N₄ film 106 are removed using RIE.

Continuing as illustrated in FIG. 8B, the resist 109 is peeled; and the lower absorption layer 151, the intermediate absorption layer 152, and the upper absorption layer 153 are formed.

Then, as illustrated in FIG. 8C, TMAH (Tetra-Methyl-Ammonium-Hydroxide) is used to perform anisotropic wet etching to remove the sacrificial layer 104 and a portion of the upper face of the monocrystalline silicon support substrate 101; a suspended structure is formed on the monocrystalline silicon support substrate 101 (the substrate 110); and the infrared imaging device 11 of this specific example is constructed.

In such a case, the structures of the protrusion 150p, the trench 150q, and the thick portion 150t of the infrared absorption unit 150 can be controlled by the design of the thermoelectric conversion unit 120, the support body 130, and the interconnection 140 of the infrared imaging device 11.

In this specific example, the distance t2 between the face of the thermoelectric conversion unit 120 on the side opposite to the substrate 110 and the face of the support body 130 on the side opposite to the substrate 110 is 2.0 μm. Therefore, the protrusion amount of the protrusion 150p, similarly to the distance t2, is about 2.0 μm. On the other hand, the thickness of the amorphous silicon film which is the sacrificial layer 104 is 3.0 μm. Therefore, the distance t3 between the support body 130 and the lower face 150d at the protrusion 150p of the infrared absorption unit 150 is 3.0 μm.

However, as described below, the distance t2 and the distance t3 change due to the design of the thermoelectric conversion unit 120, the support body 130, and the interconnection 140 of the infrared imaging device 11 and the coverability during the formation of the sacrificial layer 104.

### Second Example

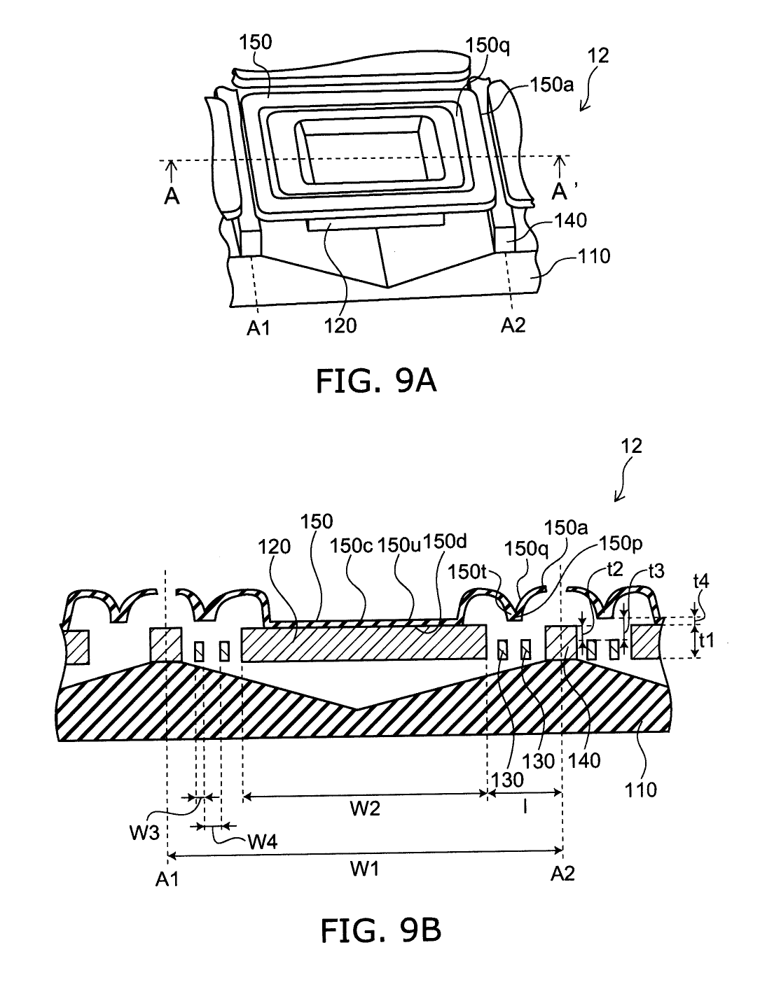

FIGS. 9A and 9B are schematic views illustrating the configuration of an infrared imaging device according to a second example. Namely, FIG. 9A is a schematic perspective view; and FIG. 9B is a cross-sectional view along line A-A′ of FIG. 9A.

In the infrared imaging device 12 according to the second example as illustrated in FIGS. 9A and 9B, the support body 130 has a structure having a bent meandering configuration. In such a case as well, the infrared absorption unit 150 includes the protrusion 150p and the trench 150q, which are provided along the rim 150a, and the thick portion 150t.

Thereby, the low mechanical strength of the rim 150a is reinforced by the protrusion 150p and the thick portion 150t; the increase of the volume of the infrared absorption unit 150 is suppressed by the trench 150q; the mechanical strength of the infrared absorption unit 150 can be increased; the sticking can be suppressed; and a highly sensitive infrared imaging device can be provided.

In the case where the support body 130 has two bent portions between the thermoelectric conversion unit 120 and one of the interconnections 140 as in the infrared imaging device 12 according to this example, the width of the protrusion 150p can be increased and the width of the trench 150q can be increased by the design of the support body 130. In such a case, for example, it is easy for the trench 150q to have a structure having a bottom face substantially parallel to the major surface of the substrate 110. Further, at least one selected from the protrusion 150p, the trench 150q, and the thick portion 150t may be multiply provided substantially parallel along the rim 150a on one side of the infrared absorption unit 150 by the design of the support body 130.

Thus, in the infrared imaging devices according to this embodiment, the numbers of the protrusions 150p, the trenches 150q, and the thick portions 150t are arbitrary.

As described above, in the infrared imaging devices 10, 10a, 10b, 10c, 11, and 12 according to this embodiment and the examples, providing the trench 150q has the effect of suppressing the increase of the volume of the infrared absorption unit 150, suppressing the increase of the thermal capacity, and increasing the sensitivity while increasing the mechanical strength of the rim 150a of the infrared absorption unit 150 due to the protrusion 150p and the thick portion 150t. Further, as described below, providing the trench 150q can increase the sensitivity by an effect other than the effect of suppressing the increase of the volume.

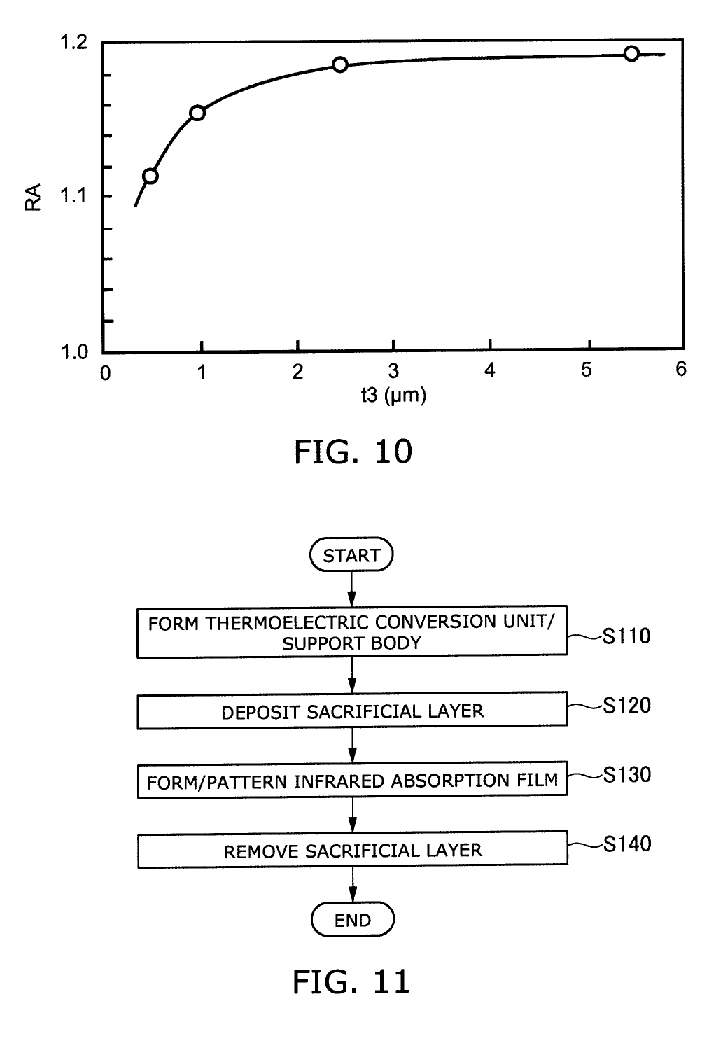

FIG. 10 is a graph illustrating a characteristic of the infrared imaging device according to the first embodiment.

Namely, FIG. 10 illustrates the result of a simulation of a light absorption amount ratio RA of infrared rays when changing the thickness of the sacrificial layer 104, i.e., the distance t3 between the support body 130 and the lower face 150d at the protrusion 150p of the infrared absorption unit 150 in the structure of the infrared imaging device 11 of the first example illustrated in FIG. 4.

In this case, the width (the wing width) W5 of the region not in contact with the thermoelectric conversion unit 120 of the infrared absorption unit 150 illustrated in FIG. 4 was constant at 6 μm; and the light absorption amount ratio of infrared rays was calculated changing the distance t3 formed reflecting the thickness of the sacrificial layer 104. In this case, a configuration was used in which the cross-sectional configuration of the peripheral portion of the infrared absorption unit 150 had an arc-like configuration having a single radius and the numbers of the protrusions 150p and the trenches 150q could change with the change of the distance t3. The thickness of the infrared absorption unit 150 was constant at 1.0 μm. In FIG. 10, the distance t3 is plotted on the horizontal axis and the infrared light absorption ratio RA is plotted on the vertical axis. The infrared light absorption ratio RA is the ratio to the case of the infrared absorption unit 150 having a flat cross-sectional configuration at the peripheral region as in the infrared imaging device 19a of the first comparative example illustrated in FIG. 2A, which is taken to be 1.

As illustrated in FIG. 10, the infrared light absorption ratio RA increases as the distance t3 increases.

In FIG. 10, the datum where the distance t3 is 0.5 μm corresponds to the case where the thickness of the sacrificial layer 104 is 0.5 μm and three combinations of the trench 150q and the protrusion 150p having the arc-like configuration are formed in the peripheral portion of the infrared absorption unit 150.

The datum where the distance t3 is 1.0 μm corresponds to the case where the thickness of the sacrificial layer 104 is 1.0 μm, two combinations of the trench 150q and the protrusion 150p having the arc-like configuration at the peripheral portion of the infrared absorption unit 150 are formed, and the outermost circumference has a configuration bent toward the substrate side.

The datum where the distance t3 is 2.5 μm corresponds to the case where the thickness of the sacrificial layer 104 is 2.5 μm and one combination of the trench 150q and the protrusion 150p having the arc-like configuration at the peripheral portion of the infrared absorption unit 150 is formed.

Thus, the infrared light absorption ratio RA increases as the distance t3 increases from 0.5 μm to 1.0 μm and to 2.5 μm. The infrared light absorption ratio RA is substantially saturated when the distance t3 is about 2.5 μm.

Thus, increasing the distance t3 increases the infrared light absorption ratio RA. This increase is caused by the depth of the trench 150q increasing due to the increase of the distance t3, which leads to an effective increase of the thickness of the infrared absorption unit 150 with respect to the incident infrared rays at the wall face of the trench 150q, and the light absorption efficiency increases.

Thus, the infrared light absorption ratio RA can be increased by increasing the thickness of the sacrificial layer 104, i.e., the distance t3 between the support body 130 and the lower face 150d at the protrusion 150p of the infrared absorption unit 150.

Here, the condition for the trench 150q to form when the protrusion 150p is formed between the support bodies 130 is as follows. That is, the trench 150q forms when Formula (1) recited below is satisfied, where D is the distance between the substrate 110 and the face of the protrusion 150 on the substrate 110 side; L is at least one selected from the distance between the thermoelectric conversion unit 120 and the support body 130, the distance between the support body 130 and the support body 130 adjacent thereto (the distance between the support bodies 130), and the distance between the support body 130 and the interconnection 140; and T is the film thickness of the flat region of the infrared absorption unit 150.

L>(2D+2T) (1)

In this specific example, this condition is

W4>(2×t4+2×t1+2T) (2)

The condition for the trench 150q to form when forming the protrusion 150p on the support body 130 is as follows. That is, the trench 150q forms when Formula (3) recited below is satisfied, where the face of the thermoelectric conversion unit 120 on the side opposite to the substrate 110 is higher than the face of the support body 130 on the side opposite to the substrate 110, I is the distance between the thermoelectric conversion unit 120 and the interconnection 140 (referring to FIG. 4), B is the distance between the support body 130 and the face of the protrusion 150p on the substrate 110 side, and T is the film thickness of the flat region of the infrared absorption unit 150.

L>(2B+2T) (3)

In this specific example, this condition is

W4>(2×t3+2T) (4)

Formula (3) and Formula (4) correspond to the condition for the trench 150q to form in the case where the protrusion 150p and the trench 150q are formed by the method illustrated in FIG. 5A to FIG. 8C (i.e., the case where a spacing of the distance W4 is provided between the thermoelectric conversion unit 120 and the support body 130, a difference in levels (the distance t2) is subsequently provided between the thermoelectric conversion unit 120 and the support body 130, and then the sacrificial layer 104 is provided thereon).

Formula (1) to Formula (4) recited above are conditions for the trench 150q to form in the case where the sacrificial layer 104 is deposited substantially isotropically.

In the case where Formula (1) to Formula (4) are not satisfied, for example, the sacrificial layer 104 is too thick; the upper face of the sacrificial layer 104 does not reflect the gap between the support body 130 and the thermoelectric conversion unit 120 and the gap between the support body 130 and the interconnection 140 and undesirably is planarized; and the trench 150q of the infrared absorption unit 150 is not formed or has a shallow depth.

Because the distance t3 between the support body 130 and the lower face 150d at the protrusion 150p of the infrared absorption unit 150 substantially matches the thickness d of the sacrificial layer, Formula (3) becomes Formula (5) recited below.

I>(2d+2T) (5)

By satisfying at least one selected from Formula (1) to Formula (5) recited above, the trench 150q is formed; the infrared light absorption ratio RA is increased; and, as described above, the increase of the volume of the infrared absorption unit 150 is suppressed, the increase of the thermal capacity is suppressed, and the sensitivity can be increased while increasing the mechanical strength of the rim 150a of the infrared absorption unit 150 due to the protrusion 150p and the thick portion 150t.

On the other hand, the condition for the thick portion 150t to form between the support bodies 130 is as follows. That is, the thick portion 150t forms when 2D<L<(2D+2T), where D is the distance between the substrate 110 and the face of the thick portion 150t on the substrate 110 side; L is at least one selected from the distance between the thermoelectric conversion unit 120 and the support body 130, the distance between the support body 130 and the support body 130 adjacent thereto (the distance between the support bodies 130), and the distance between the support body 130 and the interconnection 140; and T is the film thickness of the flat region of the infrared absorption unit 150. In this specific example, this condition is (2×t4+2t1)<L<(2×t4+2×t1+2T).

The condition for the thick portion 150t to form on the support body 130 is as follows. That is, the thick portion 150t forms on the support body 130 when 2B<I<(2B+2T), where the face of the thermoelectric conversion unit 120 on the side opposite to the substrate 110 is higher than the face of the support body 130 on the side opposite to the substrate 110, I is the distance between the thermoelectric conversion unit 120 and the interconnection 140, and B is the distance between the support body 130 and the face of the protrusion 150p on the substrate 110 side. In this specific example, this condition is 2t3<I<(2×t3+2T).

### Second Embodiment

FIG. 11 is a flowchart illustrating a method for manufacturing an infrared imaging device according to a second embodiment.

The method for manufacturing the infrared imaging device according to this embodiment is a method for manufacturing an infrared imaging device, the device including: the substrate 110; the infrared absorption unit 150 provided on the substrate 110 and apart from the substrate 110 to absorb infrared rays; the thermoelectric conversion unit 120 provided apart from the substrate 110 and in contact with the infrared absorption unit 150 between the infrared absorption unit 150 and the substrate 110 to convert a temperature change due to infrared rays absorbed by the infrared absorption unit 150 into an electrical signal; the support body 130 transmitting the electrical signal from the thermoelectric conversion unit 120 while supporting the thermoelectric conversion unit 120 on the substrate 110 and apart from the substrate 110; and the interconnection 140 used to read the electrical signal from the support body 130. That is the interconnection 140 is configured to transmit the electrical signal in reading the electrical signal.

In the method for manufacturing the infrared imaging device according to this embodiment, first, the thermoelectric conversion unit 120 and the support body 130 are formed on the substrate 110 (step S110).

Then, the sacrificial layer 104 is deposited using CVD to cover the thermoelectric conversion unit 120 and the support body 130 (step S120).

For example, as described in regard to FIGS. 5A to 5C, the sacrificial layer 104 may include amorphous silicon. Then, the thermoelectric conversion unit 120 and the support body 130 can be covered by using CVD that moderately follows the planar configuration of the thermoelectric conversion unit 120, the planar configuration of the support body 130, and the planar configuration between the thermoelectric conversion unit 120 and the support body 130. Then, the protrusion 150p and the trench 150q can be formed easily in the infrared absorption unit 150 described below formed on the sacrificial layer 104.

Subsequently, as illustrated in FIG. 6A, the resist 105 is provided on the sacrificial layer 104; and the sacrificial layer 104 is patterned into a prescribed configuration.

In other words, it is sufficient to provide the sacrificial layer 104 using CVD to cover the thermoelectric conversion unit 120 and the support body 130; and the method of patterning the configuration of the sacrificial layer 104 is arbitrary.

Then, after step S120, an infrared absorption film served as the infrared absorption unit 150 is formed on the sacrificial layer 104; and the configuration of the infrared absorption film is patterned (step S130). The method described in regard to FIG. 6A to FIG. 8C may be employed.

Then, the sacrificial layer 104 is removed (step S140).

Thereby, the protrusion 150p and the trench 150q can be provided along the rim of the infrared absorption unit 150; the thick portion 150t can be provided; the sticking can be suppressed by increasing the mechanical strength of the infrared absorption unit 150; and a highly sensitive infrared imaging device can be provided.

In such a case, the trench 150q can be formed appropriately by making settings to satisfy Formula (1) to Formula (5) recited above.

Hereinabove, exemplary embodiments of the invention are described with reference to specific examples. However, the invention is not limited to these specific examples. For example, one skilled in the art may similarly practice the invention by appropriately selecting specific configurations of components included in infrared imaging devices and methods for manufacturing infrared imaging devices from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all infrared imaging devices and methods for manufacturing infrared imaging devices practicable by an appropriate design modification by one skilled in the art based on the infrared imaging devices and the methods for manufacturing infrared imaging devices described above as embodiments of the invention also are within the scope of the invention to the extent that the purport of the invention is included.

Furthermore, various modifications and alterations within the spirit of the invention will be readily apparent to those skilled in the art. All such modifications and alterations should therefore be seen as within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

1. An infrared imaging device, comprising:
a substrate;
an infrared absorption unit provided on the substrate and apart from the substrate to absorb an infrared ray;
a thermoelectric conversion unit provided apart from the substrate and in contact with the infrared absorption unit between the infrared absorption unit and the substrate, the thermoelectric conversion unit being configured to convert a temperature change due to the infrared ray absorbed by the infrared absorption unit into an electrical signal and to output the electrical signal;
a support body supporting the thermoelectric conversion unit on the substrate and apart from the substrate, the support body being configured to transmit the electrical; and
an interconnection connected with the support body and configured to transmit the electrical signal in reading the electrical signal,
the infrared absorption unit including a protrusion provided on a rim of the infrared absorption unit to protrude toward the substrate.

2. The device according to claim 1, wherein the protrusion is provided along the rim.

3. The device according to claim 1, wherein the infrared absorption unit further includes a trench provided on a face of the protrusion opposite to the substrate, the trench being recessed toward the substrate.

4. The device according to claim 3, wherein the trench is provided along the rim.

5. The device according to claim 3, wherein the protrusion and the trench are provided continuously along the rim of the infrared absorption unit to enclose a central portion of the infrared absorption unit, the central portion being an inner side of the rim.

6. The device according to claim 1, wherein D, L, and T satisfy L>(2D+2T), where D is a distance between the substrate and a face of the protrusion on the substrate side, L is at least one distance selected from a distance between the thermoelectric conversion unit and the support body, a distance between the support bodies, and a distance between the support body and the interconnection, and T is a film thickness of a flat region of the infrared absorption unit.

7. The device according to claim 1, wherein a face of the thermoelectric conversion unit opposite to the substrate is higher than a face of the support body opposite to the substrate, and I, B, and T satisfy I>(2B+2T), where I is a distance between the thermoelectric conversion unit and the interconnection, B is a distance between the support body and a face of the protrusion on the substrate side, and T is a film thickness of a flat region of the infrared absorption unit.

8. The device according to claim 1, wherein the infrared absorption unit includes a first infrared absorption layer made of a first material, a second infrared absorption layer made of the first material, and a third infrared absorption layer made of a second material provided between the first infrared absorption layer and the second infrared absorption layer, the second material having a light absorption wavelength region different from a light absorption wavelength region of the first material.

9. The device according to claim 1, wherein the thermoelectric conversion unit includes a silicon pn junction diode.

10. The device according to claim 1, wherein a distance between the substrate and a face of the thermoelectric conversion unit opposite to the substrate is longer than a distance between the substrate and a face of the support body opposite to the substrate.

11. An infrared imaging device, comprising:
a substrate;
an infrared absorption unit provided on the substrate and apart from the substrate to absorb an infrared ray;
a thermoelectric conversion unit provided apart from the substrate and in contact with the infrared absorption unit between the infrared absorption unit and the substrate, the thermoelectric conversion unit being configured to convert a temperature change due to the infrared ray absorbed by the infrared absorption unit into an electrical signal and to output the electrical signal;
a support body supporting the thermoelectric conversion unit on the substrate and apart from the substrate, the support body being configured to transmit the electrical signal; and
an interconnection connected with the support body and configured to transmit the electrical signal in reading the electrical signal,
the infrared absorption unit including a thick portion on a rim of the infrared absorption unit, a thickness of the thick portion being thicker than a thickness of a central portion of the infrared absorption unit.

12. The device according to claim 11, wherein the thick portion is provided continuously along the rim of the infrared absorption unit to enclose the central portion.

13. The device according to claim 11, wherein D, L, and T satisfy 2D<L<(2D+2T), where D is a distance between the substrate and a face of the thick portion on the substrate side, L is at least one distance selected from a distance between the thermoelectric conversion unit and the support body, a distance between the support bodies, and a distance between the support body and the interconnection, and T is a film thickness of a flat region of the infrared absorption unit.

14. The device according to claim 11, wherein a face of the thermoelectric conversion unit opposite to the substrate is higher than a face of the support body opposite to the substrate, and I, B, and T satisfy 2B<I<(2B+2T), where I is a distance between the thermoelectric conversion unit and the interconnection, B is a distance between the support body and a face of the protrusion on the substrate side, and T is a film thickness of a flat region of the infrared absorption unit.

15. The device according to claim 11, wherein a distance between the substrate and a face of the thermoelectric conversion unit opposite to the substrate is longer than a distance between the substrate and a face of the support body opposite to the substrate.

16. The device according to claim 11, wherein the infrared absorption unit includes a first infrared absorption layer made of a first material, a second infrared absorption layer made of the first material, and a third infrared absorption layer made of a second material provided between the first infrared absorption layer and the second infrared absorption layer, the second material having a light absorption wavelength region different from a light absorption wavelength region of the first material.

17. The device according to claim 11, wherein the thermoelectric conversion unit includes a silicon pn junction diode.

18. A method for manufacturing an infrared imaging device, the device including: a substrate; an infrared absorption unit provided on the substrate and apart from the substrate to absorb an infrared ray; a thermoelectric conversion unit provided apart from the substrate and in contact with the infrared absorption unit between the infrared absorption unit and the substrate to convert a temperature change due to the infrared ray absorbed by the infrared absorption unit into an electrical signal and to output the electrical signal; a support body supporting the thermoelectric conversion unit on the substrate and apart from the substrate, the support body being configures to transmit the electrical signal; and an interconnection connected with the support body and configured to transmit the electrical signal in reading the electrical signal, the method comprising:
forming the thermoelectric conversion unit and the support body on the substrate;
depositing a sacrificial layer by chemical vapor deposition to cover the thermoelectric conversion unit and the support body;
forming an infrared absorption film served as the infrared absorption unit on the sacrificial layer and patterning a configuration of the infrared absorption film; and
removing the sacrificial layer.

19. The method according to claim 18, wherein D, L, and T satisfy L>(2D+2T), where D is a distance between the substrate and a face of the protrusion on the substrate side, L is at least one distance selected from a distance between the thermoelectric conversion unit and the support body, a distance between the support bodies, and a distance between the support body and the interconnection, and T is a film thickness of a flat region of the infrared absorption unit.

20. The method according to claim 18, wherein a face of the thermoelectric conversion unit opposite to the substrate is higher than a face of the support body opposite to the substrate, and I, d, and T satisfy I>(2d+2T), where I is a distance between the thermoelectric conversion unit and the interconnection, d is a thickness of the sacrificial layer, and T is a film thickness of a flat region of the infrared absorption unit.
